(19) United States
(12) Patent Application Publication
(10) Pub. No.: US 2015/0075267 A1
(43) Pub. Date: Mar. 19, 2015

(54) FUEL TANK PRESSURE SENSOR RATIONALITY TEST FOR A PHEV

(71) Applicant: FORD GLOBAL TECHNOLOGIES, LLC, DEARBORN, MI (US)

(72) Inventors: MICHAEL STEPHEN SWEPPY, MANCHESTER, MI (US); AED M. DUDAR, CANTON, MI (US); ROBERT ROY JENTZ, WESTLAND, MI (US)

(73) Assignee: FORD GLOBAL TECHNOLOGIES, LLC, DEARBORN, MI (US)

(21) Appl. No.: 14/027,274

(22) Filed: Sep. 16, 2013

(51) Int. Cl. G01L 23/24; G01F 23/14

(52) U.S. Cl. CPC G01L 23/24; G01F 23/14
USPC 73/114.43

(57) ABSTRACT

A method for verifying reliable operation of a fuel tank pressure transducer coupled to a fuel tank of a PHEV. The method monitors pressure and fuel level within the fuel tank, employing a fuel level sensor providing fuel level signals to a controller, as well as a pressure transducer providing pressure signals to the controller. The system identifies a sloshing event, as indicated by high amplitude, rapidly fluctuating fuel level signals, and it then analyzes the vapor dome pressure signals to determine whether vapor dome pressure signals respond to the sloshing event. Reliable operation of the fuel tank pressure transducer is indicated upon a determination that the vapor dome pressure signals appropriately respond to the sloshing event.

### TECHNICAL FIELD

Embodiments of the present disclosure generally relate to Evaporative Emission Control Systems (EVAP) for automotive vehicles, and, more specifically, to pressure sensors disposed within the fuel tanks of Plug-in Hybrid Electric Vehicles (PHEVs) incorporating EVAP systems.

### BACKGROUND

Gasoline, used as an automotive fuel in many automotive vehicles, is a volatile liquid subject to potentially rapid evaporation, in response to diurnal variations in the ambient temperature. Thus, the fuel contained in automobile gas tanks presents a major source of potential evaporative emission of hydrocarbons into the atmosphere. Such emissions from vehicles are termed ‘evaporative emissions’. The engine produces such vapors even if it is turned off.

Industry's response to this potential problem has been the incorporation of evaporative emission control systems (EVAP) into automobiles, to prevent fuel vapor from being discharged into the atmosphere. EVAP systems include a canister (the carbon canister) containing adsorbent carbon) that traps fuel vapor. Periodically, a purge cycle feeds the captured vapor to the intake manifold for combustion, thus reducing evaporative emissions.

Hybrid electric vehicles, including plug-in hybrid electric vehicles (HEV's or PHEV's), pose a particular problem for effectively controlling evaporative emissions with this kind of system. Although hybrid vehicles have been proposed and introduced in a number of forms, these designs all provide a combustion engine as backup to an electric motor. Primary power is provided by the electric motor, and careful attention to charging cycles can produce an operating profile in which the engine is only run for short periods. Systems in which the engine is only operated once or twice every few weeks are not uncommon. Purging the carbon canister can only occur when the engine is running, of course, and if the canister is not purged, the carbon pellets can become saturated, after which hydrocarbons will escape to the atmosphere, causing pollution.

Further, PHEVs have a sealed fuel tank, designed to withstand differences in pressure and vacuum within the tank resulting from diurnal ambient temperature variations. Sealing the fuel tank in these vehicles is important; otherwise the canister may be excessively loaded with fuel vapors. A Fuel tank pressure transducer (FTPT), being a high pressure sensor, is generally disposed within the fuel tank, to measure tank pressure. As the tank is sealed, the FTPT is always at a specific pressure or vacuum condition, and therefore, it becomes difficult to rationalize the FTPT to atmospheric reference conditions. Also, performing a rationality test to ensure effective operation is difficult in PHEVs, as the tank cannot be easily vented. In any event, venting would not be desirable, as that action could emit hydrocarbons to the atmosphere, causing pollution. Further, during a refueling event, the refueling door of a PHEV is not opened until the fuel-system is depressurized. If the FTPT is not fails in a higher range, the fuel tank depressurization logic will prevent the refueling door from opening since the interior pressure is high. In such cases, the operator may need to manually override the system, requiring a T-handle to open the refueling door.

Considering the problems mentioned above, and other shortcomings in the art, there exists a need for a more effective and efficient method and a system for ensuring reliable operations of the fuel tank pressure transducer positioned within the fuel tank of a vehicle.

### SUMMARY

The present disclosure provides a system and a method for ensuring reliable operation of a fuel tank pressure transducer (FTPT) coupled to a fuel tank of a plug-in hybrid electric vehicle.

One aspect of the disclosure is a method for verifying reliable operation of a fuel tank pressure transducer coupled to a fuel tank of a PHEV. The method monitors pressure and fuel level within the fuel tank, employing a fuel level sensor providing fuel level signals to a controller, as well as a pressure transducer providing pressure signals to the controller. The system identifies a sloshing event, as indicated by high amplitude, rapidly fluctuating fuel level signals, and it then analyzes the vapor dome pressure signals to determine whether vapor dome pressure signals respond to the sloshing event. Reliable operation of the fuel tank pressure transducer is indicated upon a determination that the vapor dome pressure signals appropriately respond to the sloshing event.

Additional aspects, advantages, features and objects of the present disclosure would be made apparent from the drawings and the detailed description of the illustrative embodiments construed in conjunction with the appended claims that follow.

### BRIEF DESCRIPTION OF THE DRAWINGS

FIG. 1 is a schematic view of a conventional Evaporative Emission Control System configured to reduce vehicle evaporative emissions.

FIG. 2 is a schematic view of an exemplary Evaporative Emission Control system configured to ensure reliable operation of a fuel tank pressure transducer coupled to the fuel tank, according to an embodiment of the present disclosure.

FIG. 3 illustrates an exemplary method for ensuring reliable operation of a fuel tank pressure transducer coupled to a fuel tank of a vehicle, in accordance with the present disclosure.

FIG. 4 is a graph depicting response of a reliably operative fuel tank pressure transducer to fuel sloshing within the tank.

### DETAILED DESCRIPTION OF ILLUSTRATIVE EMBODIMENTS

The following detailed description illustrates aspects of the disclosure and its implementation. This description should not be understood as defining or limiting the scope of the present disclosure, however, such definition or limitation being solely contained in the claims appended to the specification. Although the best mode of carrying out the invention has been disclosed, those in the art would recognize that other embodiments for carrying out or practicing the invention are also possible.

Environmental regulators are steadily tightening the standards for vehicle vapor emissions. Environmental authorities in certain regions, such as California, typically require less than about 500 mg of hydrocarbons released as vehicle evaporative emissions in a standard 3 day test. Given other sources of emissions, the standard effectively limits canister emissions to less than about 200 mg. Euro 5/6 regulations enforce a limit of about 2 grams of evaporative emissions per day. Such stringent conditions demand a highly efficient and effective evaporative emission control system, which in turn should by leakage free.

The On-Board Diagnostic regulations mandate that the EVAP system should be regularly checked for leakage. Many conventional EVAP leakage detection monitors use an Evaporative Leak Check Module (ELCM) pump to evacuate the canister side of the system each time the monitor runs. If the fuel tank still holds pressure or vacuum, then one can infer that no leak exists, and the evacuation of the fuel tank is not initiated at all.

PHEVs have their fuel tank sealed through a Fuel tank Isolation Valve (FTIV). Sealing the fuel tank is necessary, since the engine running time in such vehicles is limited, and therefore, vaporization of the fuel due to rise in ambient temperature may saturate the carbon pellets in the canister with hydrocarbon vapors, which vapors may eventually escape the atmosphere. A fuel tank pressure transducer (FTPT) is disposed within the fuel tank, to measure pressure within the vapor dome. Because the fuel tank is sealed, its internal pressure is almost always above or below atmospheric pressure, making it difficult to rationalize or calibrate the sensor.

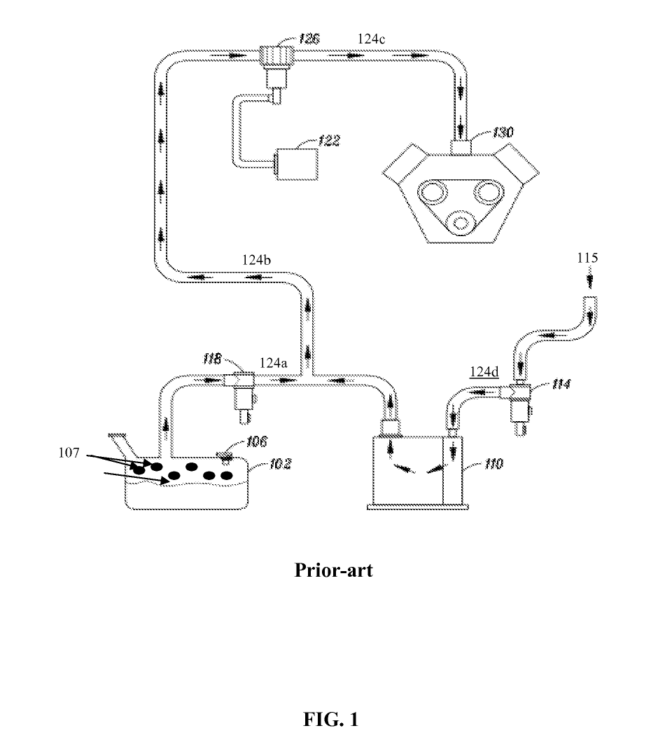

FIG. 1 illustrates a conventional evaporative emissions control system 100. The system is made up primarily of a fuel tank 102, a carbon canister 110, and the engine intake manifold 130, all joined by lines and valves. It will be understood that many variations on this design are possible, but the illustrated embodiment follows the general practice of the art. It will be further understood that the system 100 is generally sealed, with no open vent to atmosphere.

Fuel tank 102 is partially filled with liquid fuel 105, but a portion of the liquid will evaporate over time, producing fuel vapor 107 in the upper dome portion of the tank. The amount of vapor produced will depend upon a number of environmental variables. Of these factors, ambient temperature is probably the most important, particularly given the temperature variation produced in the typical diurnal temperature cycle. For vehicles in a warm climate, particularly a hot, sunny climate, the heat produced by leaving a vehicle standing in direct sunlight can produce very high pressure within the vapor dome of the tank. A fuel tank pressure sensor (FTPT) 106 monitors the pressure in the fuel tank vapor dome 107.

Vapor lines 124 join the various components of the system. One portion of that line, line 124a runs from the fuel tank 102 to carbon canister 110. A normally-closed Fuel tank isolation valve (FTIV) 118 regulates the flow of vapor from fuel tank 102 to the carbon canister 110, so that vapor generated by evaporating fuel can be adsorbed by the carbon pellets under control of the PCM 122. Vapor line 124b joins line 124a in a T intersection beyond valve 118, connecting that line with a normally closed canister purge valve (CPV) 126. Line 124c continues from CPV 126 to the engine intake manifold 130. Both CPV 126 and FTIV 118 are controlled by signals from the powertrain control module (PCM) 122.

Canister 110 is connected to ambient atmosphere at vent 115, through a normally closed canister vent valve (CVV) 114. Vapor line 124d connects that vent 115 to the canister 110. Valve 114 is also controlled by PCM 118.

During normal operation, valves 118, 126, and 114 are closed. When pressure within vapor dome rises sufficiently, under the influence, for example, of increased ambient temperature, the PCM opens valve 118, allowing vapor to flow to the canister 110, where carbon pellets adsorb fuel vapor.

To purge the canister 110, valve 118 is closed, and valves 126 and 114 are opened. It should be understood that this operation is only performed when the engine is running, which produces a vacuum at intake manifold 130. That vacuum causes an airflow from ambient atmosphere through vent 115, canister 110, and CPV 126, and then onward into intake manifold 130. As the airflow passes through canister 110, it entrains fuel vapor from the carbon pellets. The fuel vapor mixture then proceeds to the engine, where it is mixed with the primary fuel/air flow to the engine for combustion.

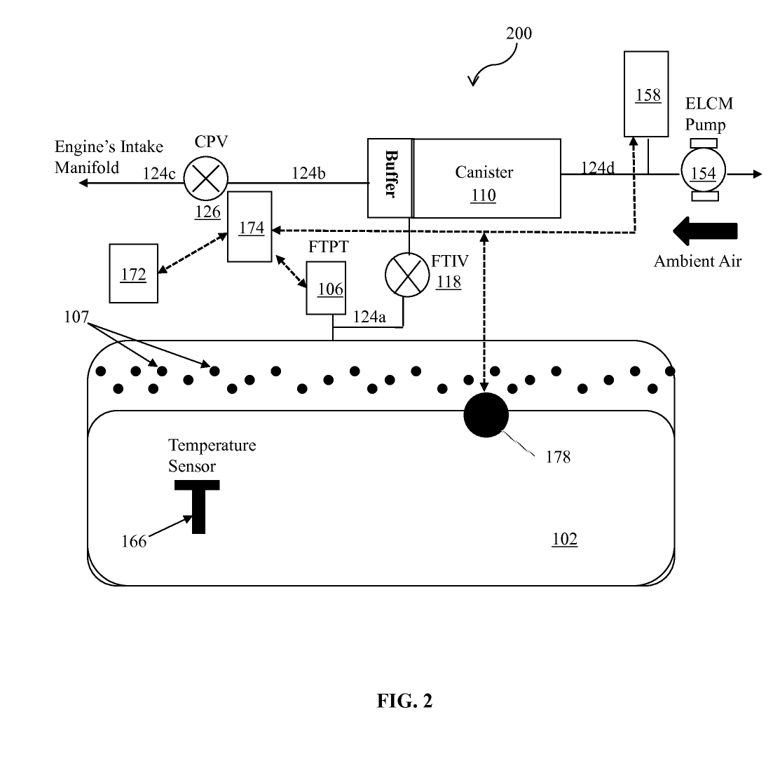

FIG. 2 is a schematic view of an Evaporative Emission Control System 200 of the present disclosure. The structural and functional difference between the illustrated embodiment and the conventional system of FIG. 1 is as follows.

First, the FTPT 118 is coupled to an electronically operated controller 174, which continuously analyzes the response of the FTPT 118 to fuel sloshing within the fuel tank 102. Basically, the controller 174 checks whether FTPT 118 detects changes in pressure within the fuel tank 102 during fuel sloshing.

To perform EVAP leakage detection, the system 200 includes an Evaporative Leakage Check Module (ELCM). ELCM includes a pump 154, which may be a vacuum pump of the type commonly employed by the art to evacuate EVAP systems.

An additional pressure sensor 158 is also positioned at the flow line 124d, to measure fuel-system pressure at the outlet vent.

A temperature sensor 166 is positioned within fuel tank 102, to measure its interior temperature. Though only one temperature sensor 166 is shown, multiple sensors may be employed. An average of the temperature values detected by those sensors can be taken to obtain a more precise measure of the temperature within the interior of the fuel tank 102.

A fuel level indication sensor 178 is provided within the fuel tank 102, to monitor the level of fuel contained within the tank.

FIG. 2 illustrates an EVAP system 200, according to the present disclosure. This system ensures reliable operation of FTPT 106. It should be noted that the present disclosure presumes that FTPT 106 has been subjected to, and has passed, the basic operation test. That is, upon startup, or periodically, the system has ensured that a signal is being received from FTPT 106, and that the signal has been subjected to a basic determination that the reported pressure value lies within an expected range. Thus, if FTPT 106 signals a pressure value outside a predetermined range of potentially valid readings, then the system flags an error for immediate attention.

Generally, system 200 identifies a situation in which all the fuel tank 102 experiences a “sloshing” event, and it employs the natural results of sloshing to perform a rationality test on FTPT 106. As used here, “sloshing” refers to back and forth movement of liquid fuel within the tank, in response to the vehicle's acceleration or. Sloshing may occur, for example, when the vehicle accelerates or decelerates suddenly on a flat road surface, or takes a sharp turn, or encounters a speed bumps or potholes. Cumulatively, all such events are termed ‘acceleration/deceleration events’ in the discussion that follows. In some embodiments, a controller 174 may be coupled to an acceleration/deceleration sensor positioned within the vehicle for identifying acceleration/deceleration events. In addition, as noted above, controller 174 also continuously receives pressure signals from FTPT 106.

Fuel sloshing is produced by an acceleration or deceleration of the vehicle, which can occur in any direction. A speed bump or pothole, for example, will impose sudden acceleration with a strong vertical component. Turns, particularly sudden or sharp turns, similarly produce acceleration in a horizontal plane. Acceleration in the real world will often have both vertical and horizontal components, all of which will produce wave action within the fuel tank, resulting in sloshing.

Sloshing can be detected indirectly, by sensing an acceleration/deceleration event, or directly by monitoring the fuel level. In the illustrated embodiment, the direct method is employed, using a fuel level sensor, such as float sensor 178. The sensor can directly monitor changes in fuel level that result from an acceleration/deceleration event. It will be understood that float sensor 178 must be sufficiently sensitive to respond to and signal all relatively rapid changes in fuel level that occur during wave action within the fuel tank. Alternatively, the system can employ an acceleration sensor 172, whose output is coupled to the controller 174. By arranging several sensors oriented in different planes, any acceleration can be detected and reported.

Sloshing involves rapid, turbulent motion, which includes waves impacting the walls of fuel tank 102. This motion naturally produces fuel vapor, which of course increases pressure within the tank. That increase should be reported by the FTPT 106. If controller 174 does not receive such an indication, the system concludes that the FTPT 106 is stuck in range, either at a high or a low pressure value, and is unreliable. If the controller does receive a pressure change indication, however, then the system 200 concludes that the FTPT 106 passes the rationality test.

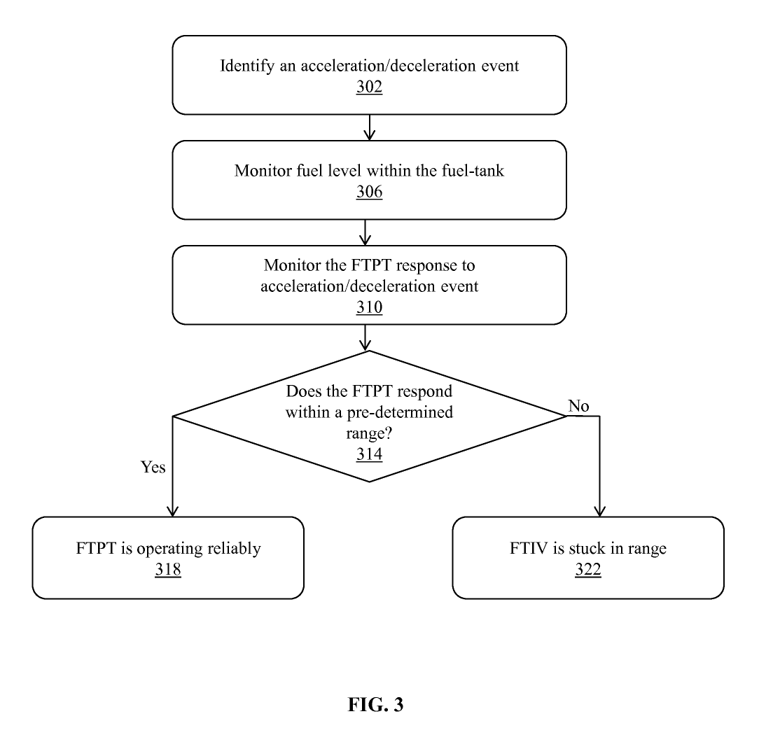

FIG. 3 is a flowchart depicting the different steps involved in a method for ensuring reliable operation of a Fuel tank pressure transducer coupled to a fuel tank of a PHEV, according to the present disclosure.

As shown, at step 302, the method detects an acceleration/deceleration event for a vehicle. In certain embodiments, the method detects acceleration/deceleration values only beyond a minimum threshold, so that lesser degrees of fuel sloshing may occur within the fuel tank without triggering the method described here. The method can employ either an acceleration sensor, such as acceleration sensor 172, or a fuel sensor, such as float sensor 178, for this purpose. Both of these sensors are well known by an available to the art, adaptable to a variety of operating environments. Also, both sensors are coupled to controller 174 to provide continuous signaling. It will be understood that both acceleration sensor 172 and float sensor 178 are depicted here for completeness, but inoperable installation will most likely contain only one such sensor.

At step 306, the method monitors the level of fuel contained with the fuel tank 102. As noted above, the fuel level indicator 178 disposed within the fuel tank 102 monitors the fuel level and signals the results. Continuing to step 310, controller 174 monitors the response of FTPT 106 to fuel sloshing. Controller 174 monitors signals received from FTPT 106, and it proceeds to analyze those signals to identify significant change in those values to determine the FTPT response. Those of skill in the art will be able to define what constitutes a “slosh” for purposes of the present method. For example, some embodiments may choose to key on the amplitude of a fuel level perturbation to identify slosh, while others may look for a rapid series of up-and-down motions. A combination of such events may be chosen as the most accurate indicator of sloshing. In any event, those in the art will also understand that oversampling, which simply results in additional testing, is a lesser danger than experiencing the failure of FTPT 106.

At step 314, the system determines whether the FTPT 106 responds in line with the fuel sloshing during the acceleration/deceleration event. Some embodiments may choose a rather a relatively simple comparison, such as looking to the percentage variation of fuel level compared with the percentage variation of pressure. Other systems may use pattern recognition techniques to compare the two responses. Again, it should be emphasized that the objective of the present method is to determine simply that the FTPT 106 is not stuck in range. Relatively sophisticated analysis techniques may not be required here.

If FTPT 106 is responding in an acceptable manner, then at step 318, then the system can infer that the FTPT 106 is operating reliably. If FTPT 106 does not respond acceptably, then the method concludes at step 322 that the FTPT most likely is stuck in range, and is therefore unreliable. The system may then provide an indication to the operator, either visually, audibly or otherwise, that a maintenance technician needs to examine the sensor.

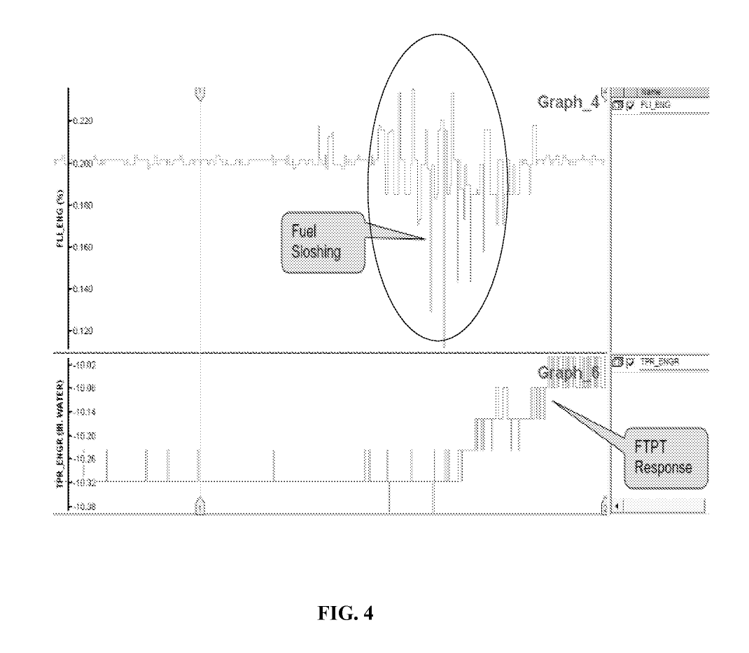

FIG. 4 is a graph depicting the response of both FTPT 106 and float sensor to a sloshing event. Here, the upper trace, Graph_{—}4 response to float sensor 178, and the lower trace, Graph_{—}6 response to FTPT 106. The left half of the chart shows normal operation, with minor variations in the fuel level, and similarly minor variations in the vapor dome pressure. Essentially, the signals reflect the noise of normal operation. Then, Graph_{—}4 shows high-amplitude, rapidly spaced level changes. The fact that the changes swing to both very high and very low levels reflects the physical fact that an acceleration/deceleration event as generated wave motion inside the fuel tank. That motion rises to extreme levels very quickly, and equally quickly damps out in the absence of further acceleration/deceleration stimulus. Graph_{—}6, on the other hand, likewise reflects the physical events inside the tank as well. Here, pressure only begins rising after the sloshing event is well underway, because the additional vapor is only released as a result of the sloshing, and thus its accumulation lags the sloshing event itself. While the sloshing action gradually subsides, the pressure level continues to build, because condensation requires some time. Well after the sloshing has ceased, vapor dome pressure levels out. If the chart were to be extended for additional time, one would expect the pressure level to return to the baseline, but only relatively slowly.

Given an understanding of the physical phenomena involved, those of skill in the art can readily construct pattern recognition algorithms to first recognize a sloshing event and then to correlate the sloshing event with expected responses from FTPT 106. With that understanding, the system can reliably conduct a rationality test to determine whether FTPT 106 is stuck in range.

The method and the system of the present disclosure is highly effective in ensuring reliable operation of the Fuel tank pressure transducers coupled to the fuel tanks in PHEVs, and easily overcomes problems faced by conventional rationality tests for such vehicles, which majorly rely on venting the fuel tank, or on the engine running time.

Although the current invention has been described comprehensively, in considerable details to cover the possible aspects and embodiments, those skilled in the art would recognize that other versions of the invention are also possible.

What is claimed is:

1. A method for verifying reliable operation of a fuel tank pressure transducer coupled to a fuel tank of a PHEV, comprising:
monitoring fuel level in the fuel tank, employing a fuel level sensor providing fuel level signals to a controller;
monitoring pressure within a vapor dome of the fuel tank pressure, employing a pressure transducer providing pressure signals to the controller;
identifying a sloshing event, as indicated by high amplitude, rapidly fluctuating fuel level signals;
analyzing the vapor dome pressure signals to determine whether vapor dome pressure signals respond to the sloshing event; and
indicating reliable operation of the fuel tank pressure transducer upon a determination that the vapor dome pressure signals appropriately respond to the sloshing event.

2. The method of claim 1, further comprising, indicating unreliable operation of the fuel tank pressure transducer, if the transducer does not respond appropriately to the sloshing event.

3. The method of claim 1, wherein the sloshing event corresponds to one or more of cases where:
the vehicle accelerates on a road surface;
the vehicle decelerates on a road surface;
the vehicle takes a turn; or
the vehicle encounters a bumpy surface.

4. A method for verifying reliable operation of a fuel tank pressure transducer coupled to a fuel tank of a PHEV, comprising:
detecting a vehicle acceleration/deceleration event, employing an acceleration sensor providing acceleration signals to a controller;
monitoring pressure within a vapor dome of the fuel tank pressure, employing a pressure transducer providing pressure signals to the controller;
identifying a sloshing event, as indicated by high amplitude, rapidly fluctuating acceleration signals;
analyzing the vapor dome pressure signals to determine whether vapor dome pressure signals respond to the sloshing event; and
indicating reliable operation of the fuel tank pressure transducer upon a determination that the vapor dome pressure signals appropriately respond to the sloshing event.

5. The method of claim 4, further comprising, indicating unreliable operation of the fuel tank pressure transducer, if the transducer does not respond appropriately to the sloshing event.

6. The method of claim 4, wherein the sloshing event corresponds to one or more of cases where:
the vehicle accelerates on a road surface;
the vehicle decelerates on a road surface;
the vehicle takes a turn; or
the vehicle encounters a bumpy surface.
